(19) United States
(12) Patent Application Publication
(10) Pub. No.: US 2013/0139057 A1
(43) Pub. Date: May 30, 2013

(54) METHOD AND APPARATUS FOR AUDIO REMIXING

(71) Applicant: Jonathan A.L. Vlassopulos, San Francisco, CA (US)

(72) Inventor: Jonathan A.L. Vlassopulos, San Francisco, CA (US)

(21) Appl. No.: 13/377,088

(22) PCT Filed: Jun. 8, 2010
(86) PCT No.: PCT/US10/37852

§ 371 Date: Dec. 8, 2011

Related U.S. Application Data
(60) Provisional application No. 61/268,100, filed on Jun. 8, 2009.

(51) Int. Cl. G06F 3/16

(52) U.S. Cl. CPC G06F 3/162
USPC 715/716

(57) ABSTRACT

A software application for use on a portable communications device, such as a cellphone, personal digital assistant, personal computer, or other device capable of receiving user inputs and providing audio playback, allows users to select a track and add samples and effects to create a personal audio remix. The user may then share their creation with other users and friends via, for example, e-mail, social networking or specialized community sites for users of the application. Effects may be further generated using an internal accelerometer of the device. Samples and effects are stored with respect to the timing of the selected master track.

### CROSS-REFERENCE TO RELATED APPLICATIONS

This application claims priority under 35 U.S.C. §371 to PCT Patent Application Ser. No. PCT/US2010/037852 entitled METHOD AND APPARATUS FOR AUDIO REMIXING filed in the name of Jonathan Antony Lee Vlassopulos et al., with an international filing date of Jun. 8, 2010 and designating the United States, which in turn claims priority under 35 U.S.C. §119 to U.S. Provisional Patent Application Ser. No. 60/268,100 entitled METHOD AND APPARATUS FOR AUDIO REMIXING filed in the name of Jonathan Antony Lee Vlassopulos et al. on Jun. 8, 2009, the entirety of each are herein incorporated by reference.

### TECHNICAL FIELD

This disclosure generally relates to audio data processing, and in particular it relates to sound editing and remixing.

### BACKGROUND

Music is universal in its appeal and digital music continues to grow in popularity. Remixing is a growing emerging trend in the industry.

Various prior remixing applications have been available, including BEATNIK'S MIXMAN application. With MIXMAN, users can select from different audio loops to play back. The user turns audio loops from an associated song on/off and they begin playback in synchronized time with the other tracks. Users can apply audio effects, such as a filter, to the overall mix.

Emerging hardware and software technologies now allow for an enhanced remixing application that offers new features to users as described herein below.

### SUMMARY

The present disclosure introduces a method implemented entirely in software for use on an apparatus, such as a mobile personal communications device, for accomplishing personal audio remixing of a desired audio track. The software may be provided in an application, sometimes referred to herein as “ROMPLR.” ROMPLR allows users to interact with a song by providing audio loops and samples of instruments and vocals from a master recording, which can be triggered by engaging buttons on the device interface (for example, a touch screen, accelerometer, hard-key input, or mouse input). ROMPLR provides the next generation of music experience, being both interactive and participatory. It invites artist fans to feel and experience the artist's music in a new way. It allows fans to take the artist's music and make it their own.

Whereas prior remix applications are generally MIDI based, ROMPLR utilizes pure audio loops. ROMPLR synchronizes the playback of, for example, eight true audio loops. It should be readily apparent that any number of loops can be implemented and used. The Master Clock Loop (MCL) is the shortest loop and is definable on the backend as being one of the user-selectable loops or can be an additional loop that is never visible/played for the user. The lengths of other loops featured in the individual ROMPLR track are all multipliers of the Master Clock Loop (MCL). In addition to the eight loops, ROMPLR also features seven “one-hit” samples that the user can initiate playback on demand. In addition, the user is able to solo one or two loops to create a unique mix.

ROMPLR uses a master audio loop as the loop synchronization clock. Most audio devices use well-known SMPTE or MIDI formats, which allow for more control over tempo and real-time playback. ROMPLR's use of the master loop as a clock has allowed a method for determining song synchronization that is proprietary to the song and how the audio has been cut. It also allows any song used to be synchronized without resorting to creating MIDI versions of playback or shifting the timing of actual audio, thereby saving processing time. ROMPLR's record feature uses its own data template to recreate performances. This is similar to how MIDI performs, but is not MIDI.

In particular, BEATNIK'S MIXMAN differs from ROMPLR in the manner the technology is implemented. ROMPLR uses actual audio loops (i.e., in .WAV or similar audio format) to control playback, synchronization and tempo. MIXMAN, on the other hand, uses MIDI events to play synthesized and sampled without reference to the master clock of the track. This is a fundamental technology difference that is readily apparent to one of ordinary skill in the art. ROMPLR further records its own proprietary data to control the playback of audio stems to save audio mixes. ROMPLR may use a touch screen user interface (UI) on a mobile device, such as an IPOD or IPHONE from APPLE for providing actuable and trigger-able controls to a user.

### BRIEF DESCRIPTION OF THE DRAWINGS

Further aspects of the present disclosure will be more readily appreciated upon review of the detailed description of its various embodiments, described below, when taken in conjunction with the accompanying drawings, of which:

FIGS. 1 and 2 are an overview of a user's ROMPLR experience;

FIG. 3 is an example of a ROMPLR user interface on an IPHONE or similar device;

FIGS. 4-6 are an exemplary diagram of available ROMPLR functions and sub-functions;

FIG. 7 is a flowchart of an exemplary ROMPLR mix process;

FIG. 8 is a flowchart of an exemplary ROMPLR play process;

FIG. 9 is a flowchart of an exemplary ROMPLR record process;

FIGS. 10-12 are flowcharts of an exemplary ROMPLR play/record complete process; and

FIG. 13 is a flowchart of an exemplary ROMPLR publication process.

### DETAILED DESCRIPTION

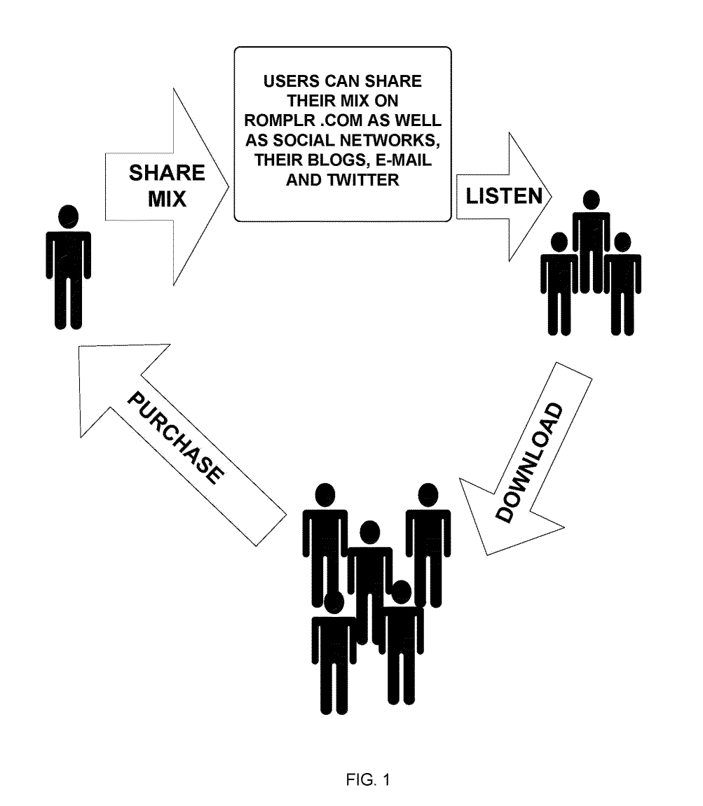

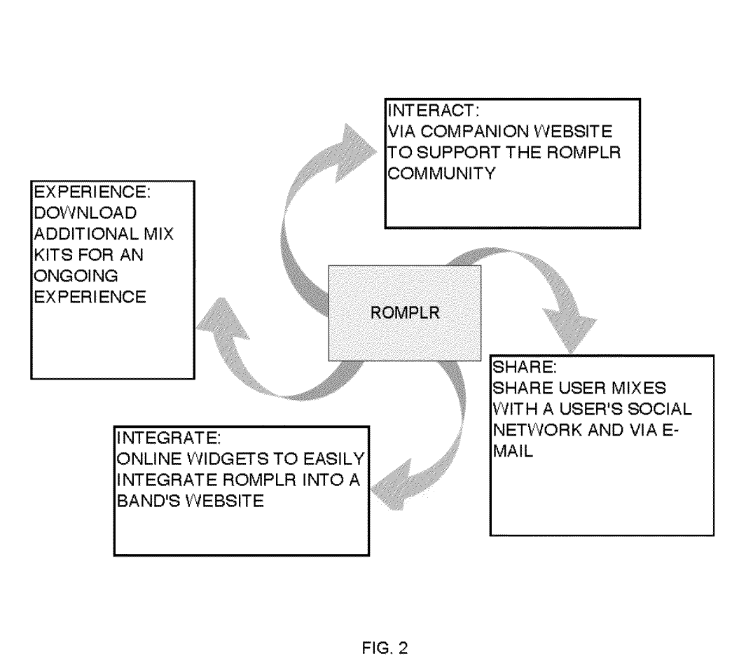

In various embodiments, ROMPLR is an application for audio remixing that allows users to easily create custom song mixes from tracks of recorded music. ROMPLR will initially launch as an IPHONE and IPOD TOUCH application, with a companion online community available over the Internet to drive contests and extend the ROMPLR experience. As depicted in FIGS. 1 and 2, ROMPLR enables users to connect to their favorite band's music in a unique and personal way, by creating and sharing their own versions of tracks while maintaining the spirit of the original music. Users can generate and share their mixes via e-mail, blogs and other social networking/Internet locations where other people may find, download, purchase or listen to them.

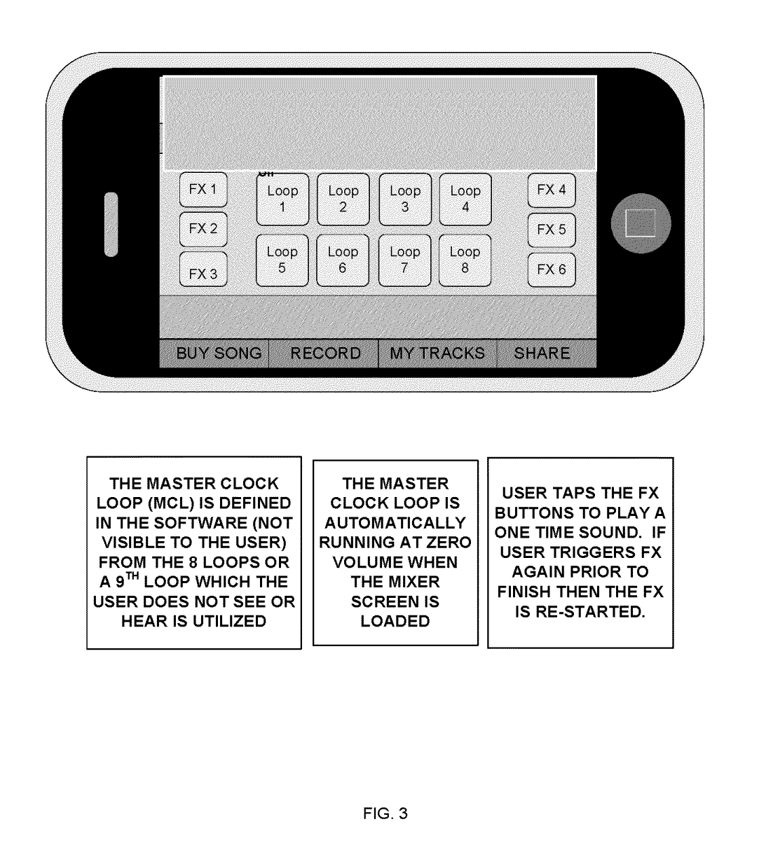

Turning to FIG. 3, therein is depicted an exemplary device on which the ROMPLR application software may be implemented. It is readily contemplated that the device be portable, having a portable housing containing a display (such as a touchscreen display) providing one or more virtual or physical user-actuated buttons. The device has a processor and storage capabilities that are implemented in any of a variety of manners readily known to one of ordinary skill in the art. The device may also be able to communicate stored data to an external device such as a server on a computer network or the Internet. In various embodiments, the device may be a cell phone, a personal computer, a personal media player, a personal digital assistant, a tablet device, a portable game player or other similar device. In certain embodiments, the device is equipped with an internal accelerometer, which may be used as an input to ROMPLR and to signal any motion of the portable device. While any of a variety of commercially available devices are readily available for use with ROMPLR, it will described herein as implemented on an APPLE IPHONE, ITOUCH or other similar device with its known components.

An exemplary implementation of ROMPLR may include the following features available to a user:
three “mix kits,” where each mix kit contains a number of loops corresponding to a selected track, as well as effects for application to the loops by a user.
Each mix kit may provide eight loops with six or more samples and effects each.
A selected sample or effect may be applied to a mix by shaking the IPHONE or other device to use the internal accelerometer thereof to select an associated sample or effect.
Record and share remixes with other users via e-mail, online social networks and other electronic communications media.
Companion website/widgets to support online integration of generated mixes.
ITUNES integration (or an interface with other music web site) for artist track purchases.

As shown in FIG. 3, the ROMPLR interface presented therein may include the following exemplary elements:
eight loop trigger buttons (“Loop 1”-“Loop 8” buttons in FIG. 3) which can be used to engage, disengage or feature playback of an audio loop. Each loop may be a separate portion of a track (such as drumline, bassine, guitar, keyboard or vocals) of a set duration. Engaged loops run continuously from beginning to end until disengaged. One of the loops may be designated as a master clock loop (MCL) from which the timing of all other added loops and effects are coordinated and stored.
six sample trigger buttons which can be used to engage one time playback of a sample sound (“FX 1”-“FX 6” effects buttons in FIG. 3)
one sample trigger assigned to the internal accelerometer of an IPHONE device or the like, which may engage a one time playback of a sample sound modified when the device is shaken.
Audio effect generation via a touch-screen sliding switch or the like (not shown) that allows frequency filtering of the entire audio output based on the position of the sliding switch using a bandpass or other filter to generate an equalization curve at various frequencies, as selected by the user. The filter selection may be likewise recorded by the ROMPLR application when actuated by a user.
A loop “snap to zero” button, which sends all active loops back to the beginning of playback.
A Record feature that records data for all button usage on a timeline based on the master track. The data can be used to play back a user's mix on a ROMPLR enabled device (mobile phone/flash player) or sent to a server on a network, such as the Internet, to build an actual audio file (.WAV, .MP3 etc.) of the mix by splicing together all the audio loops and samples in the order they were performed on ROMPLR (where the recorded timeline determines how to put the audio together on the server side).
Access to an online community where users can upload their mix data for playback on the web. Users will be able to hear and rate each others mixes.
Downloadable mix kits of audio for assignment to the ROMPLR keys.
A “My Tracks” feature for storing and saving user-generated mixes at the user's selection.
A “Buy” button by which a user may interface with a website to purchase a track for remixing.
A “Share” button for sharing generated re-mixes with other persons.

In various embodiments, ROMPLR would receive source audio tracks as sub-mixed track stems culled from the original master session by the recording artist as a stereo 16-bit, 44.1 kilohertz (kHz,) .WAV (or similar audio format) file. For example, all drum tracks would be sub-mixed to one stereo .WAV, grouped background vocals mixed to one stereo .WAV, lead vocals mixed to one stereo .WAV, etc.

However, if sub-mixed track stems are not made available, then sub-mixed track stems from the original full master sessions would be created. This process involves taking large, complicated multi-track sessions, isolating the most logical sub-groups (e.g. drums, guitars, keyboards, etc.) and bouncing each (with any corresponding processing) to a stereo 16-bit, 44.1 kHz, .WAV file, or the like, while maintaining the overall integrity of the original full mix.

It is important to note here, that even if ROMPLR receives sub-mixed track stems the further editorial process noted below is still necessary, as sub-mixed track stems each run the entire length of the song and ROMPLR loops are generally speaking usually no longer than thirty to forty seconds, though in some case an individual loop may run as long as a minute (i.e. loops one through six might be the building blocks of a repeated chorus while loop seven might be a longer vocal passage that runs over several repetitions of said chorus).

Editorial Process

Depending on the melodic content of the song, careful consideration must be made concerning the selection of the final audio files which will make up the audio bundle or mix kit that is generated for a user based on a selected track.

If the original track has more than one broad melodic passage, the most important passage should be selected. For example, if the track in question has a traditional verse/chorus structure, where the verse and chorus have related but fundamentally different chord structures, either a verse OR a chorus must be selected. Otherwise the possibility is left open for the user to simultaneously play a verse on top of a chorus, which though rhythmically might match, tends to melodically result in an unpleasant cacophony.

It is generally advised that loops of high melodic content should all be of identical length, so as to remove the possibility that the user might offset two melodic passages which could result in an unpleasant cacophony. However, it is commonplace in popular beat-based music for the verse and chorus to not be distinguished by fundamentally distinct chord structures, so that verse and chorus elements can be simultaneously sounded without unpleasant dissonance. In other words, in beat-based music, one could successfully deliver six accompaniment loops of a chorus along side two loops of a verse and not worry that the result would be unpleasant or dissonant.

Special care must be taken in choosing the Master Clock Loop. Ideally it should be as short as possible (to ensure the quickest start-up time for the user when mixing and provide maximum responsiveness for loop cueing), yet not so short that it leaves open the possibility that the user might offset two melodic or syncopated passages which could result in an unpleasant cacophony.

All loops must be exact multiples of the Master Clock Loop in length. If the Master Clock Loop is two seconds long, all loops should be at least exactly two seconds long or exactly four seconds (twice as long), exactly six seconds (three times as long), and so on. This rule even holds for musical patterns that don't begin immediately on the beginning of each Master Clock Loop. For example, if the Master Clock Loop is two bars of 120 beats per minute (bpm) and a second loop is a melodic passage that begins on the 2^{nd} beat of a two bar pattern, the delivered audio must contain the first beat of silence.

One-hits should be chosen from throughout the track stems. Generally, a good mix of instrumental hits, vocal hits both long and short is advised. Take special care to ensure that all one-hits sit well on top of the loops.

Lastly, a density check should be performed to ensure that with all loops running simultaneously, the result is still pleasing sonically and not distorting the device speakers. The rule “less is more” should be squarely in mind.

Audio Bundle Contents

ROMPLR supports the download of “Mix Kits” which are a collection of audio loops, audio samples and graphics that can change the look and playback of the device.

Once selected, the following may be delivered as part of the audio bundle comprising an exemplary “mix kit”:
A. Eight clean loops of stereo 16-bit, 44.1 kHz, .WAV (or similar formatted audio) file to ultimately be converted to 16-bit, 22.050 kHZ, stereo .CAF or similar files for packaging. One loop should be selected as the Master Clock Loop, which will represent the longest possible wait for additionally triggered loops to cue. For synchronization purposes, the seven remaining loops must all be increments of the Master Clock Loop's length (i.e. If the Master Clock Loop is two bars of 120 bpm (four seconds long), all other loops should either be exactly the same length, exactly twice as long (eight seconds), four times as long (sixteen seconds), and so on.
B. Seven one-hit samples of stereo 16-bit 44.1 kHz .WAV to ultimately be converted to 22.050 stereo .CAF files for packaging. Six of these are for manual triggering by the user via on-screen buttons over the eight aforementioned automatically synced loops. When properly equipped, an additional effect can be triggered by the user via the device's internal accelerometer by shaking the device.

Synchronized Loop Playback

The eight loops will be triggered by eight on-screen touch buttons. As soon as the mixer screen is entered, the Master Clock Loop begins silent playback. Once the user triggers one or more of the loops to start by touching its respective button(s) the button(s) will “light” and display a glow around its edges to indicate the loop is in “cue mode”, the corresponding audio is cued up and will begin immediately playing at the start of the next silent Master Clock Loop. This ensures loops will never play out of sync. Once the cued loops begin playing the glow to indicate “cue mode” fades away to indicate “loop play mode” has begun. Loops in play mode will continue to play in sync until the user ceases operation.

Solo Mode

During playback of synced loops a loop in either loop play made or off mode can be “soloed” by pressing and holding its on-screen button. Visual feedback will clearly indicate the state change from loop play mode to solo mode. Soloing a loop will instantly silence all other synced loops (regardless of the position of the Master Clock Loop) for the duration of the press-hold. Soloing a loop, however, will NOT silence any remaining audio that may be playing from any of the one-hit samples.

Duet Mode

Additionally, the user may “duet” two loops by simultaneous pressing-and-holding of two loop buttons. Visual feedback will clearly indicate that both loops have changed state to solo mode and all other loops will be instantly silenced (regardless of the position of the Master Clock Loop) for the duration of the dual press-hold. If one of the two duet-ed loops is released, the remaining press-hold will continue in solo mode as described above.

One-Hit Samples

The user can independently trigger the six additional one-hit samples at any time by touching their on-screen buttons and they will sound immediately on top of any synced loops, regardless of the position of the Master Clock Loop. The one-hit samples play their entire length when triggered, unless the same sample is re-triggered, in which case the subsequent trigger supercedes the previous trigger.

Accelerometer “Shake” Sound

The user can independently trigger the seventh addition one-hit sample via the IPHONE's built-in accelerometer by shaking the device.

Audio Loops

To create loops for use with ROMPLR, the master recording of the individual audio tracks is condensed into, for example, eight sub-mixes. Each sub-mix is then cut into a short audio loop which can be loaded into a mix kit. The audio is an actual audio file that can be turned on/off by the user. The loop continuously plays one or more bars of a song. Loop tempo cannot be varied (as with MIDI devices) since we are using actual audio, not MIDI. A master loop file is designated to determine one bar of music. Each loop will begin playback on the one count of the master loop when engaged. Loops can be disengaged at any time by triggering the loop button. If the loop button is held down for a defined period of time, all other loops are silenced (while still playing back) as a solo feature. All loop lengths must be a multiple of the master loop to ensure synchronized playback. While most software uses MIDI or SMPTE for this type of synchronization, ROMPLR uses the actual song, which allows use of actual audio from the recordings as opposed to MIDI based recreations with a synthesizer.

Samples/Effects

Short buzz words and instrument noises are created from the master recordings and can be assigned to any of the sample triggers (for example, six effects buttons and one shake button). When triggered the sample will playback the assigned audio in its entirety one time. Any subsequent triggering of the sample keys will restart the sample playback from zero. In this manner users can stutter playback of the audio.

Filter

A filter effect (generated, for example, using a high Q band pass) filter can be engaged and will affect all active audio loops. The frequency band pass of the filter is determined by a long swipe pad in the effects menu of ROMPLR. Dragging your finger across the pad (or using other interface on non-touch screen devices) will change the frequency range.

Loop Snap to Zero

A snap to zero feature forces all active loops to begin playback from the beginning of the audio file.

Record

ROMPLR's record feature does not record actual audio. It records data from when a user presses each ROMPLR button and for how long against an internal timer. This data can be saved to playback the created mix in ROMPLR by telling ROMPLR which keys to press at which timing. This data can also be loaded to our user community to play back an online flash version of ROMPLR. In this scenario the actual recording does not contain any actual audio, just data for what the user has performed. A FLASH player interprets the data and plays back the assigned audio accordingly.

The data can also be loaded to our servers to build an actual audio file from identical audio stems stored on our server. Our software interprets the user performance data and builds an audio file (.WAV, .MP3, .MP4 etc.) from the individual audio components to recreate the user's performance in a storable audio format.

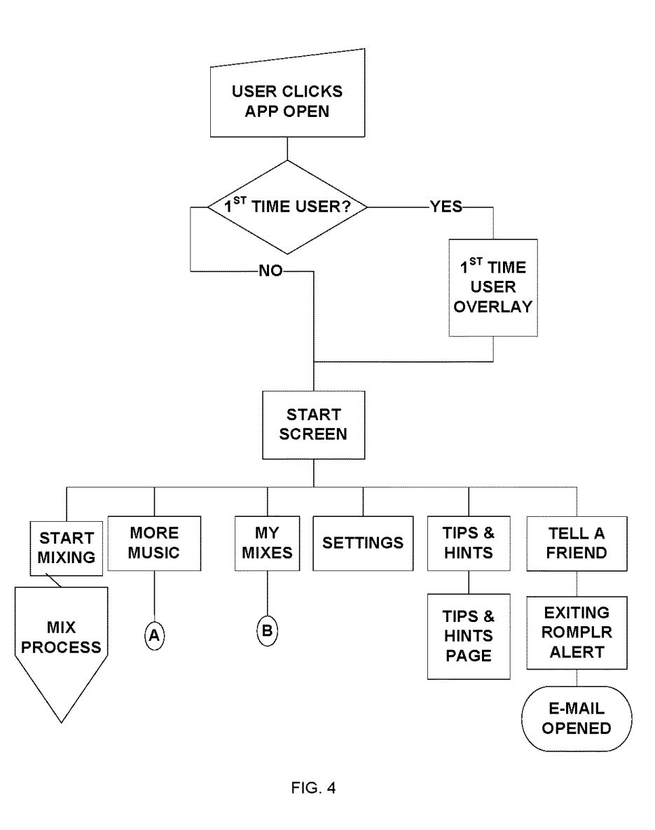

Turning now to FIG. 4, therein is depicted an exemplary process performed by the ROMPLR application upon being opened by a user on the device. If the user is a first time user, he/she is presented with a one-time overlay for registering with the ROMPLR system. A registered user may then reach the start screen in which a number of options are presented, such as starting a mix, selecting more music tracks, selecting stored music remixes, changing software settings, tips and hints for using ROMPLR and a “tell a friend feature” by which users may recommend ROMPLR to others.

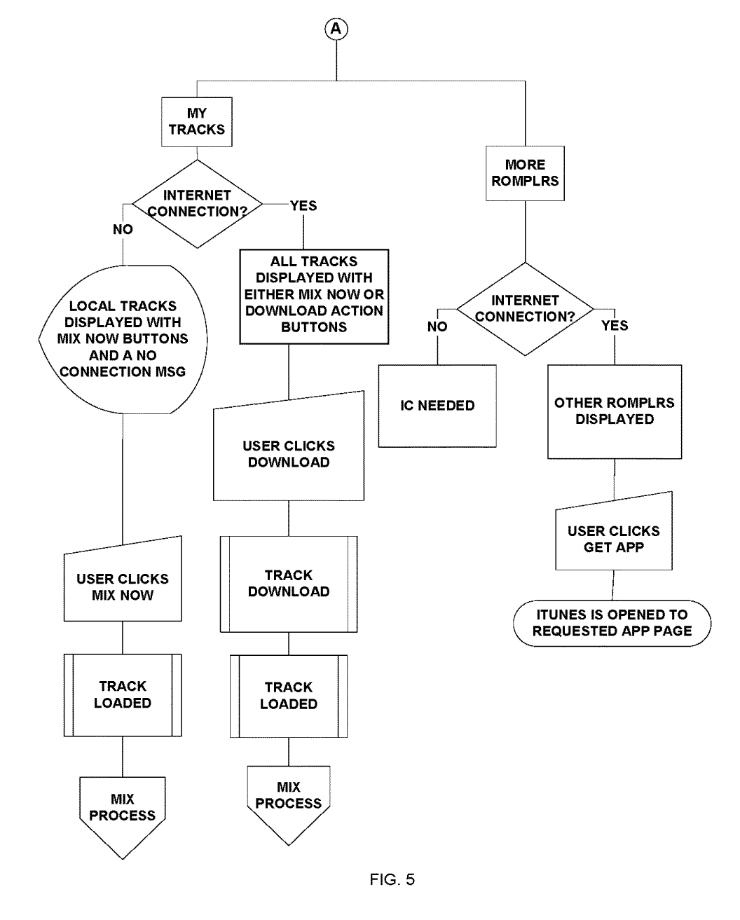

Turning to FIG. 5, when a user selects “more music” from the options in FIG. 4, the user is presented with all locally stored tracks. If the device is connected to the internet or other computer network, the user may also access, select and download tracks located at other networked locations. The user may access remixes generated from other users over such a network collection as well. After a local of network track is selected and downloaded, a user may proceed to create a re-mix from the track.

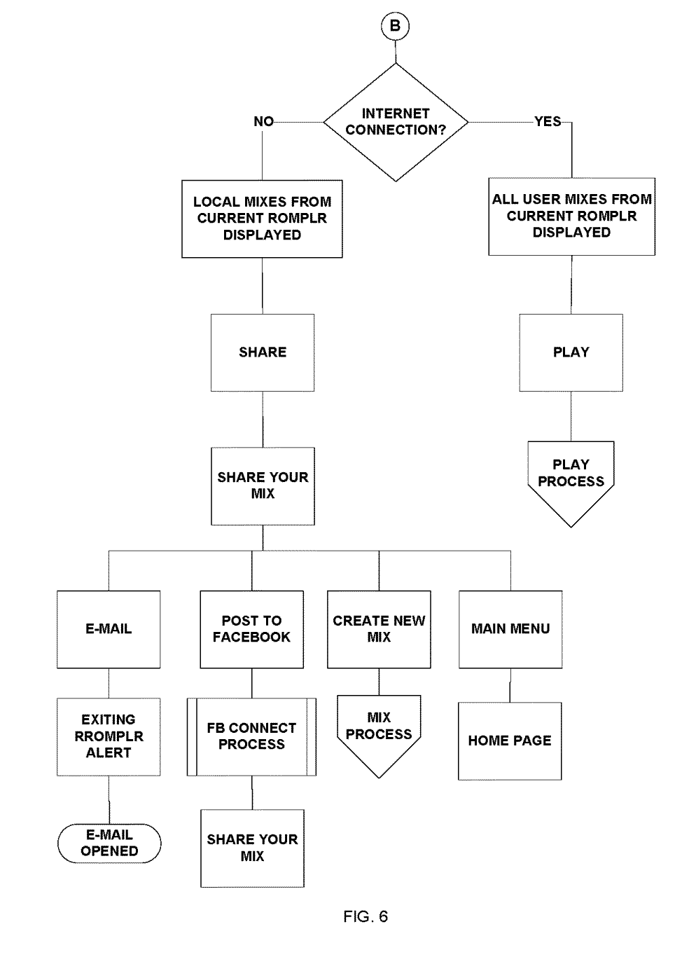

Turning to FIG. 6, when a user selects stored music remixes from the options in FIG. 4, the user is provided a list of their stored remixes on the device. The user may choose to share any of their stored remixes by e-mail, TWITTER, social networking sites, text messaging and the like. If the device is connected to a network, the user is presented with remixes from themselves or other users that may be selected and played from a location on the network.

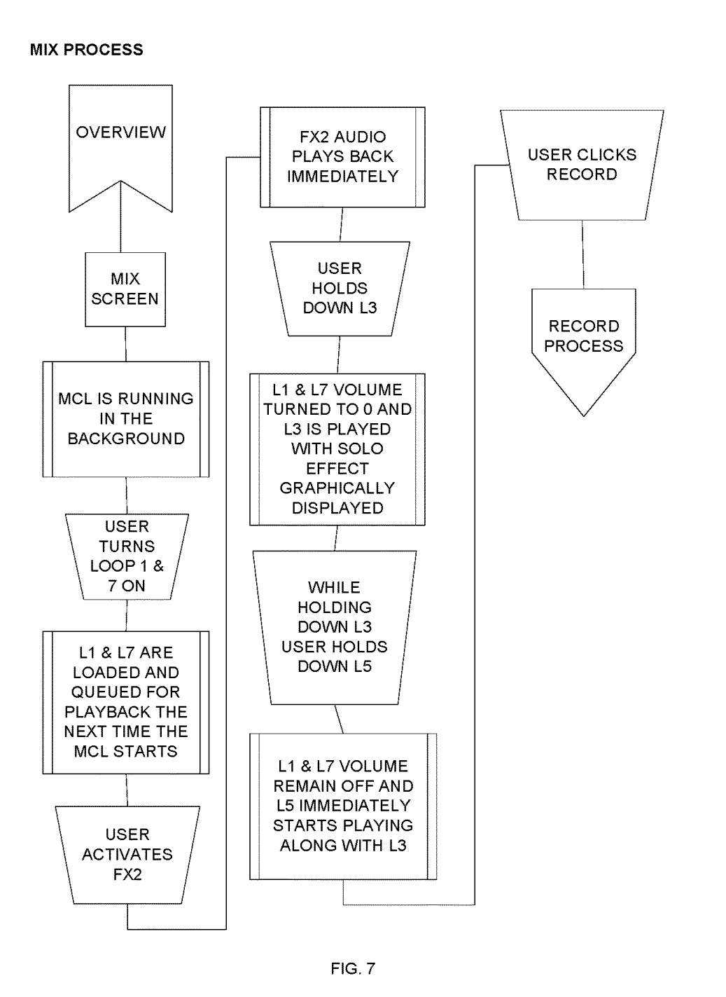

Turning to FIG. 7, therein is depicted an exemplary mixing process performed using ROMPLR on the device. A user selects a track, which has corresponding loops and available effects. An MCL is first selected. The user may turn on one or more additional loops. The additional loops will be timed to a logical playback location of the MCL, in order for the two loops to avoid being mis-timed into a cacophonous melody. Thus, additional loops may not be played back at a time selected by the user. Preferably, additional loops will be started with the start location of the MCL when it is playing and continuously looped.

The user may also activate effects buttons during playback of the MCL and one or more additional loops. The effect will be played with the MCL at the time of the selection of the effect by the user. The user may also add filter effects and change volumes of the one or more loops and effects during playback.

When a user is satisfied with the selection of loops and effects, the remix may be recorded at the users selection.

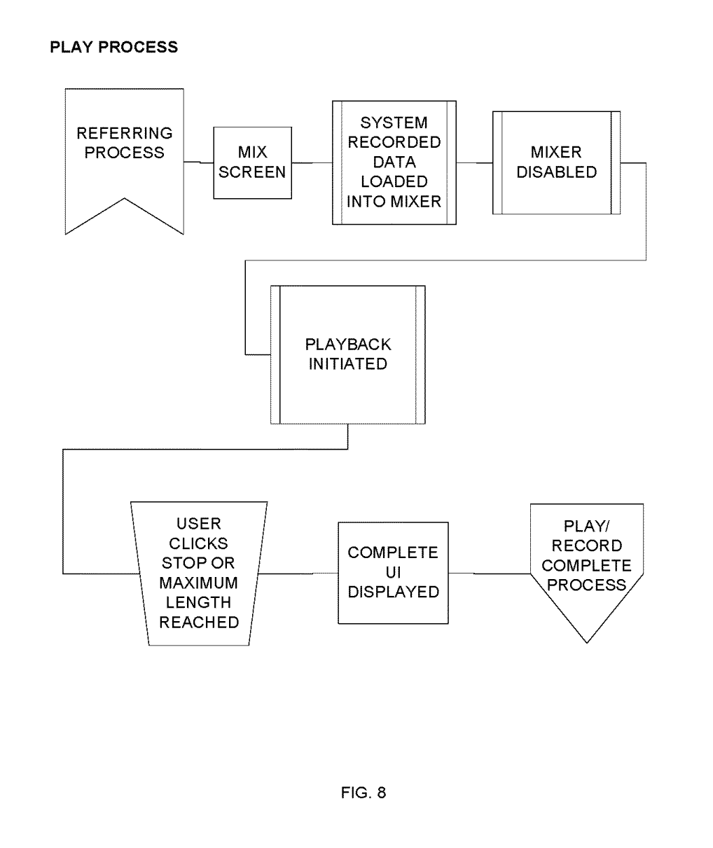

Turning now to FIG. 8, therein is depicted a playback process by which a user may select and play a stored remix. The selected remix is played upon actuation by the user and continues until the user stops the playback or the maximum run length of the track is reached.

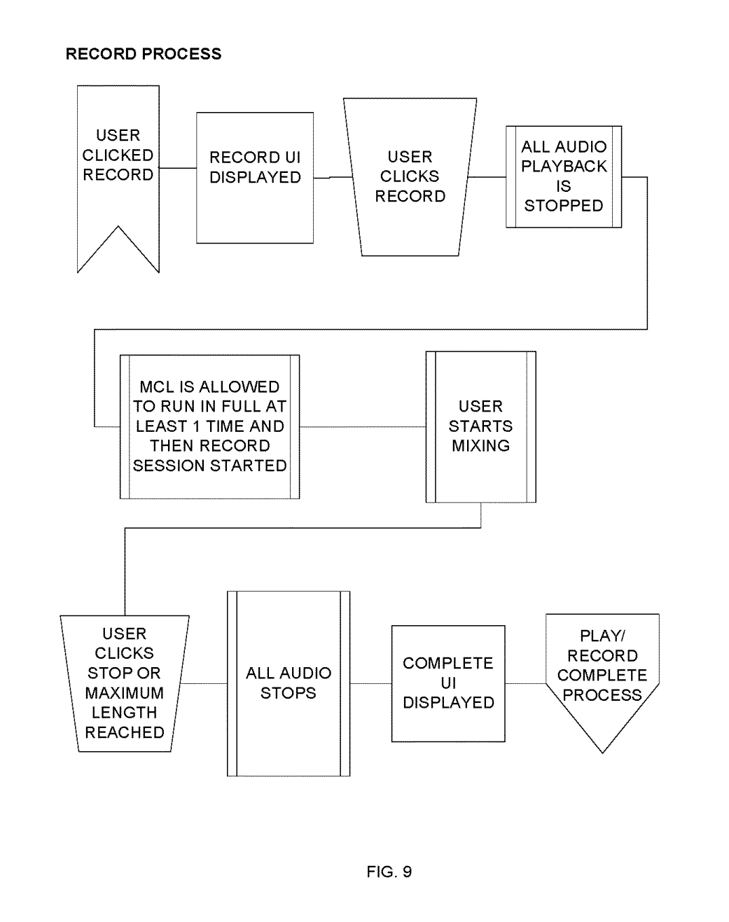

Turning to FIG. 9, therein is depicted a record process by which a user may record a remix. Upon selecting the record button, the MCL is allowed to run once before a user adds additional loops and effects. Once all loops and effects are added the user may stop the recording or allow it to record to maximum permitted duration.

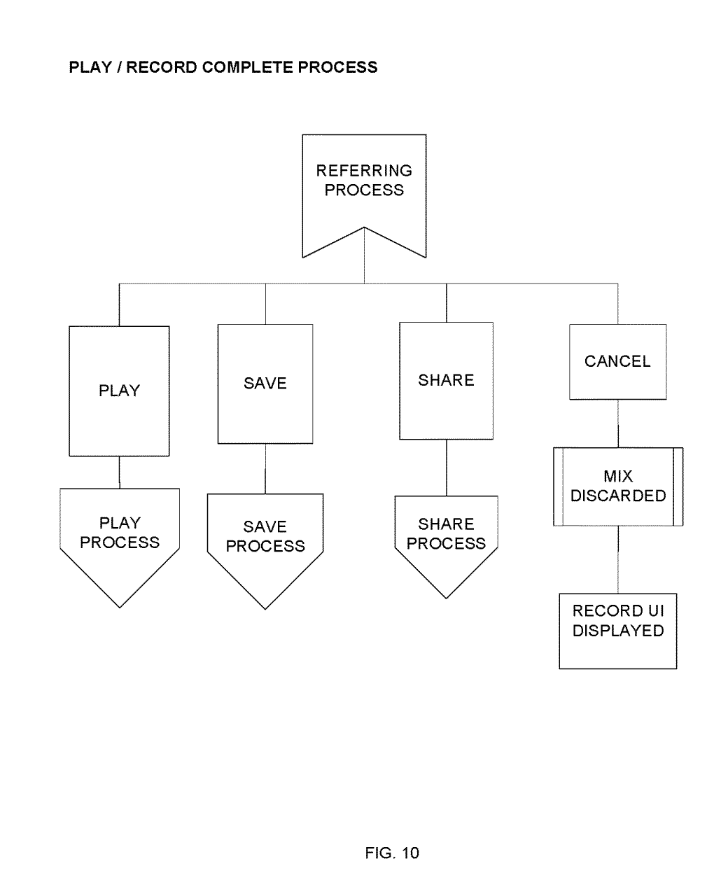

Turning to FIG. 10, once a play/record process is complete, a user may elect to play, save, share or discarded a recorded re-mix.

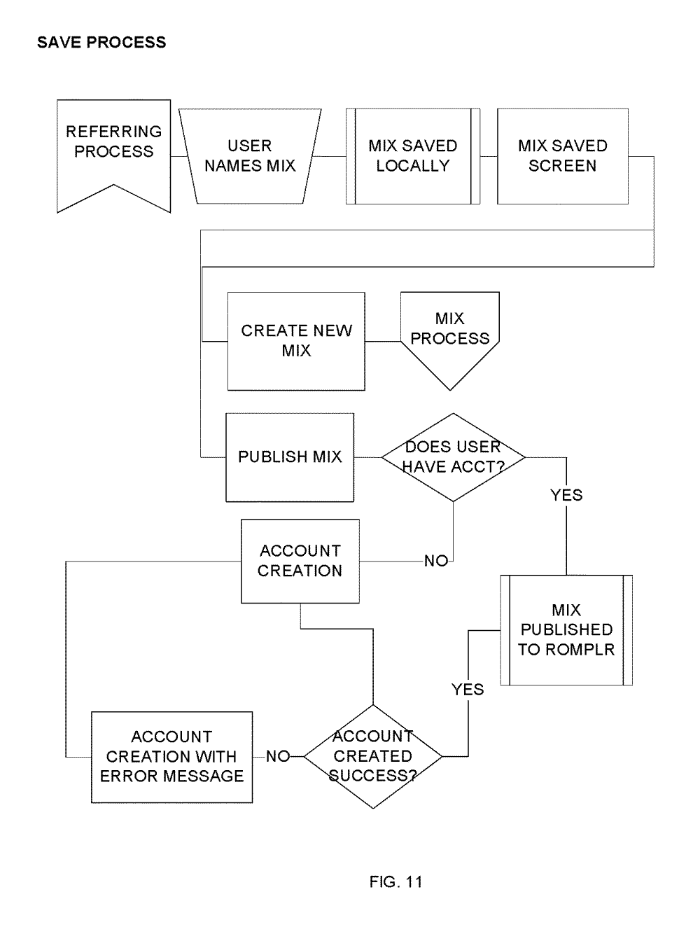

Turning to FIG. 11, the user may save the remix locally, or if he/she has or creates an account with a server on a computer network, may elect to store the track at that network location. It is important to note that ROMPLR does not create a new file from the remix. Instead, the selected loops, and the time during the MCL at which each effect and filter are selected by a user are stored in a data file. Such an exemplary data file, which contains timing data, not audio, is much more efficient to share from today's portable devices since they are of smaller file size than a comparative audio file that contains all the sounds generated by the remix. By transmitting just the track used, its version, and the timing data generated from user inputs, the file size of a remix will not occupy the bandwidth that a comparable audio file would. Such a data file also occupies less space in memory on the device or any computer. Accordingly, this provides technical benefits for the transmission and sharing of remixes that are readily recognizable to one of ordinary skill in the art.

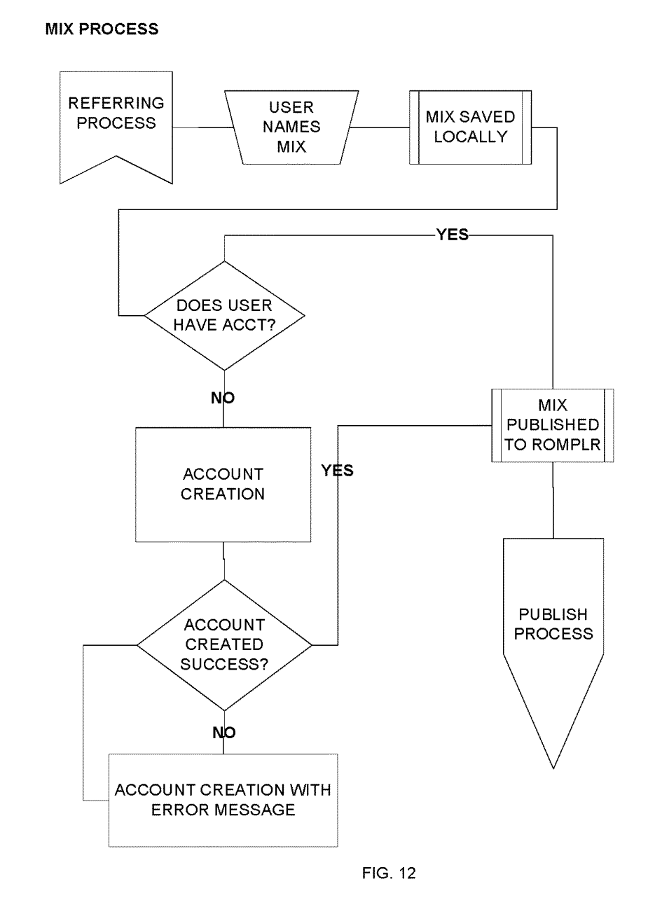

Turning now to FIG. 12, therein is depicted an exemplary mix publication process by which a user may publish his/her generated remixes to other users. The user may do this at a network location where he/she has or creates a suitable user account.

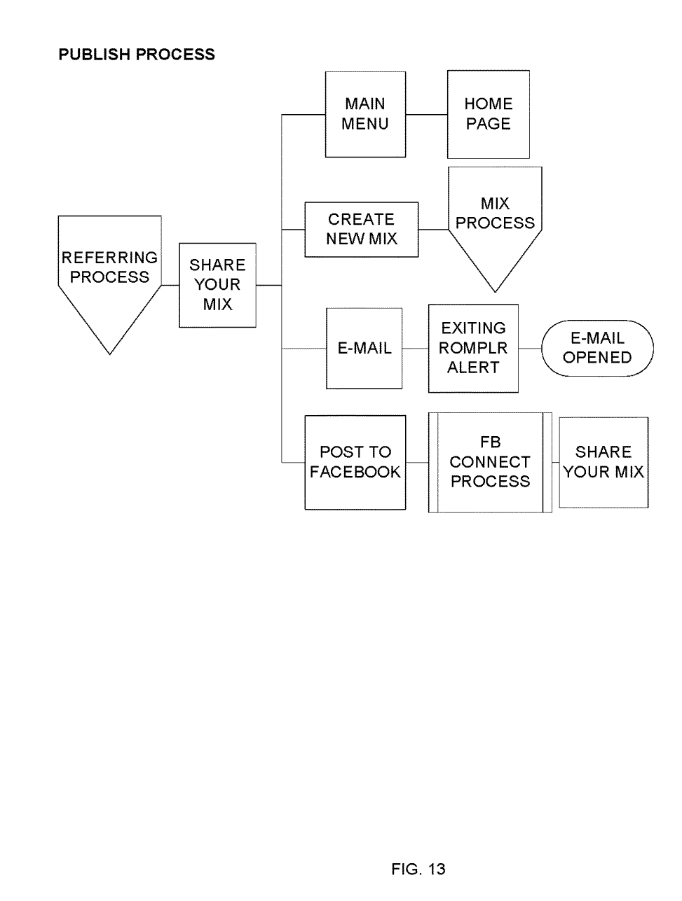

Turning to FIG. 13, therein is provided an exemplary sharing process by which a user may elect to share his/her remixes via e-mail, or social networking sites.

Additional ROMPLR features include:
Allowing a consumer to download additional ROMPLRs and interact with new content and music
Allowing users to make purchases and subscriptions from the ROMPLR application.
Utilizes a custom skin while the consumer is interacting with a specific Mix Kit
Allows consumers to record their own sample to play alongside a Mix Kit
Enable users to sing along with the their own mixes or even other user's mixes
Incorporates gaming where users can try to recreate a mix. Support both user-driven levels as well as artist-driven levels (i.e. see how close you can match a recording artist's ROMPLR Mix).
Integrating the ROMPLR community widget to support and promote brand-driven user content.
Create Artist “Mashups.”
Allow users to create a custom ROMPLR Mix Board from various different tracks and potentially different artists.
Enable users to mix with each other on ad hoc BLUETOOTH networks.
Online Widget, ANDROID, BLACKBERRY, PALM as well as JAVA.

ROMPLR supports uploading the data file to an online community built around ROMPLR products. The data file will be used to replay user mixes on the online version Flash version of ROMPLR. The community will also allow its' audience to stream audio mixes of ROMPLR built from the audio stems as mentioned in RECORD.

It is readily contemplated that ROMPLR can be used in a manner consistent with existing US and international copyright laws when the user selects a copyrighted track from which to generate a remix.

Although the best methodologies have been particularly described in the foregoing disclosure, it is to be understood that such descriptions have been provided for purposes of illustration only, and that other variations both in form and in detail can be made thereupon by those skilled in the art without departing from the spirit and scope thereof

What is claimed is:

1. A method for creating an audio remix track performed by a portable device in response to user inputs to the device, the method comprising:
receiving, from a user, a selection of a track from which a remix is to be generated;
providing a loop button that activates a loop of the track;
providing an effects button that corresponds to an audio effect to be added to the track;
receiving a selection of the loop button by the user;
playing the loop in response to the selection of the loop button;
receiving a selection of the effects button by the user;
playing an effect corresponding to the effects button in response to the selection of the effects button and at the time of the selection of the effects button;
storing a time of the loop at which the effects button was selected;
saving the loop with the stored time as a remix on the portable device; and
transmitting the loop with the stored time from the portable device to a server on a computer network, wherein the server reconstructs and stores the remix by applying the effect to the loop at the stored time.

2. The method of claim 1, wherein the effects button comprises an internal accelerometer of the device that is activated by the user shaking the device.

3. The method of claim 1, further comprising sharing the remix with other users via the server on the computer network.

4. The method of claim 1, further comprising:
providing a second loop button comprising a second loop corresponding to the track;
receiving a selection of the second loop button by the user;
playing the second loop at a second time determined only from a playback location the loop, in response to the selection of the second loop button.

5. The method of claim 4, wherein the second time does not correspond to a time the selection of the second loop button is received.

6. The method of claim 4, wherein the playback location is a start of the loop.

7. An apparatus comprising:
a portable housing;
a processor and a storage device disposed within the portable housing;
a user interface disposed within the portable housing an operatively connected to the processor and storage device;
an accelerometer disposed within the portable housing operatively connected to the processor; and
application software executable by the processor that allows a user to select an audio track and create an audio loop from the audio track using the user interface, and to add a sound effect to the audio loop using the accelerometer by shaking the portable housing.

8. The apparatus of claim 7, wherein the user interface comprises a touch-screen device.

9. The apparatus of claim 7, further comprising:
a communications interface for transmitting data to and receiving data from an external communications network, wherein the user may share the audio loop with the sound effect via the communications interface.

10. A method performed by a portable device for adding an effect to an audio loop in response to a user's input to the device, the method comprising:
receiving a selection of an audio track via a user interface of the device;
creating an audio loop from the audio track based on commands entered via the user interface;
receiving a signal from an accelerometer of the device that corresponds to a user shaking the device; and
adding a sound effect to the audio loop based on the signal.

11. The method of claim 10, the adding of the sound effect further comprising:
adding the sound effect during a playback of the audio loop at a time corresponding to a receipt of the signal.

12. The method of claim 10, further comprising:
storing the audio loop with the sound effect as a remix in a memory of the device; and
transmitting the remix to an external communications network.
